(19) United States
(12) Patent Application Publication
(10) Pub. No.: US 2010/0023303 A1
(43) Pub. Date: Jan. 28, 2010

(54) Method, Apparatus, and System for Non-Invasive Monitoring of Underground Installations

(75) Inventors: Mark Smith, Natrona Heights, PA (US); Christopher D. Carlin, Sewickley, PA (US); George L. Brandt, Bethel Park, PA (US)

Correspondence Address: THE WEBB LAW FIRM, P.C., 700 KOPPERS BUILDING, 436 SEVENTH AVENUE, PITTSBURGH, PA, 15219, US

(73) Assignee: GEOSPATIAL HOLDINGS, INC., Sarver, PA (US)

(21) Appl. No.: 12/510,509

(22) Filed: Jul. 28, 2009

Related U.S. Application Data
(60) Provisional application No. 61/084,086, filed on Jul. 28, 2008.

(51) Int. Cl. G06F 15/00; G06T 15/00

(52) U.S. Cl. 702/188; 345/419

(57) ABSTRACT

A system for non-invasive monitoring of an underground installation includes at least one monitoring installation associated with the underground installation; at least one analyzer mechanism configured to measure at least one physical characteristic associated with the at least one monitoring installation and transmit a data set at least partially representative of the at least one measured physical characteristic; and at least one computer having a computer-readable medium having stored thereon instructions, which, when executed by a processor of the computer, causes the processor to implement the instructions. The at least one computer is in communication with an input mechanism and a display unit. The at least one computer includes programming instructions adapted to operate the processor to receive the transmitted data set, and adapted to operate the processor to determine a location of the monitoring installation based at least in part on the transmitted data set.

### CROSS REFERENCE TO RELATED APPLICATIONS

This application is based on U.S. Provisional Patent Application No. 61/084,086, filed Jul. 28, 2008, on which priority of this patent application is based and which is hereby incorporated by reference in its entirety. This application is also related to co-pending U.S. patent application Ser. No. 12/484,586, filed Jun. 15, 2009, and U.S. patent application Ser. No. 12/504,854, filed Jul. 17, 2009, which are also hereby incorporated by reference in their entirety.

### BACKGROUND OF THE INVENTION

1. Field of the Invention

The present invention relates generally to methods, processes, apparatus, and systems for monitoring underground installations, structures, and objects, such as underground pipelines, and specifically to a method, apparatus, and system for the non-invasive monitoring of underground installations, structures, and objects. In one embodiment, the present invention is implemented using an autonomous, inertial-based mapping probe.

2. Description of Related Art

Pipeline owners and operators face many hazards that affect the integrity of their buried pipelines. Events such as seismic activity, ground subsidence, and/or heave, as well as the cumulative effects of ground movement over the span of many years, can all have negative or detrimental effects on buried pipelines. If unnoticed or undetected, these events and conditions often lead to catastrophic failure of a pipeline. Therefore, the ability to monitor for unwanted movement is essential to maintain the integrity of buried pipeline assets.

There are various methods currently in use within the industry to monitor pipeline integrity, but there is not a standardized approach taken in capturing measurements related to pipeline movement. Current methods vary between applications, typically incorporating technologies, such as inclinometers, piezometers, accelerometers, thermistors, wire strain gauges, etc. Each of these technologies possesses some type of drawback or limitation that has hindered widespread use. For example, wire strain gauges are attached to the pipe by welding, thereby limiting their use with ferrous material pipelines. These limitations, when coupled with the inherent expense of each technology, have caused intermittent installation and acceptance within the industry.

### SUMMARY OF THE INVENTION

Therefore, it is an object of the present invention to provide a method, apparatus, and system for the non-invasive monitoring of underground installations, structures, and objects, such as underground pipelines, that overcome some or all of the drawbacks and deficiencies evident in the prior art.

Preferably, the present invention provides a cost effective monitoring system that monitors for unwanted pipeline movement, thereby facilitating the safe operation of pipelines and other underground installations. In one preferred and non-limiting embodiment, the present invention is directed to a method, apparatus, and system that is configured to: (1) monitor a “sister” or monitoring pipeline that is attached to or otherwise associated with the pipe-to-be-monitored, or the carrier pipe; and (2) determine or produce movement data using a monitoring probe or device, such as an autonomous, inertial-based mapping probe, together with proprietary computer programming logic and proprietary software code.

Accordingly, provided is a system for non-invasive monitoring of an underground installation. The system includes at least one monitoring installation associated with the underground installation; at least one analyzer mechanism configured to measure at least one physical characteristic associated with the at least one monitoring installation and transmit a data set at least partially representative of the at least one measured physical characteristic; and at least one computer having a computer-readable medium having stored thereon instructions, which, when executed by a processor of the computer, causes the processor to implement the instructions. The at least one computer is in communication with an input mechanism and a display unit. The at least one computer includes programming instructions adapted to operate the processor to receive the transmitted data set, and adapted to operate the processor to determine a location of the monitoring installation based at least in part on the transmitted data set.

The at least one monitoring installation may be associated with the underground installation by being coupled to the underground installation or positioned near the underground installation. If the at least one monitoring installation is coupled to the underground installation, at least one of the following methods may be used: adhesive, arc welding, thermo welding, fusing, strapping, or any combination thereof. In addition, the at least one monitoring installation may be manufactured from at least one of the following: steel, aluminum, ductile iron, cast iron, concrete, asbestos, concrete asbestos, titanium, high density polyethylene, polyvinyl chloride, or any combination thereof.

The at least one analyzer mechanism may be a probe that includes internal data collection instrumentation configured to measure the at least one physical characteristic and a storage device configured to store collected data. The at least one physical characteristic may include at least one of the following: distance traveled, depth, elevation, angle, change in inclination, change in speed, or any combination thereof. The at least one analyzer mechanism may further include a communications interface to transmit the data set to the at least one computer.

The at least one computer may further include programming instructions adapted to operate the processor to convert the data received from the at least one analyzer mechanism into a readable format. The received data may include physical characteristic data in three dimensions at at least one specified point along the monitoring installation.

The at least one computer may further include programming instructions adapted to operate the processor to generate a three-dimensional array of X-Y-Z data representative of physical characteristics of the at least one monitoring installation. The at least one computer may further include programming instructions adapted to operate the processor to insert the X-Y-Z data into a model and connect points of the X-Y-Z data to form a complex line representing the at least one monitoring installation. The at least one computer may further include programming instructions to operate the processor to monitor a position of the underground installation by: (a) determining a baseline location of at least a portion of the monitoring installation based on the at least one physical characteristic associated with the at least one monitoring installation as determined by the at least one analyzer mechanism at a first time; (b) determining a second location of at least a portion of the monitoring installation based on the at least one physical characteristic associated with the at least one monitoring installation as determined by the at least one analyzer mechanism at a second time; (c) comparing the baseline location to the second location; (d) determining if a change between the baseline location and the second location indicative of a change in a position of the underground installation exists; (e) repeating steps (a) through (d) after a pre-determined time period has elapsed; and (f) alerting a user if a change between the baseline location and the second location exists. The monitoring installation may be a pipe attached to at least a portion of the underground installation.

Further provided is a computer-implemented method on at least one computer having a computer-readable medium having stored thereon instructions, which when executed by a processor of the computer, causes the processor to implement the method. The computer-implemented method includes the steps of receiving data transmitted from at least one analyzer mechanism configured to measure at least one physical characteristic associated with a monitoring installation associated with an underground installation and determining a location of the monitoring installation.

The at least one monitoring installation may be associated with the underground installation by being coupled to the underground installation or positioned near the underground installation. The at least one physical characteristic may include at least one of the following: distance traveled, depth, elevation, angle, change in inclination, change in speed, or any combination thereof.

The computer-implemented method may further include the steps of generating a three-dimensional array of X-Y-Z data representative of physical characteristics of the at least one monitoring installation, and inserting the X-Y-Z data into a model and connecting points of the X-Y-Z data to form a complex line representing the at least one monitoring installation. The method may also further include the step of monitoring a position of the underground installation by: (a) determining a baseline location of at least a portion of the monitoring installation based on the at least one physical characteristic associated with the at least one monitoring installation as determined by the at least one analyzer mechanism at a first time; (b) determining a second location of at least a portion of the monitoring installation based on the at least one physical characteristic associated with the at least one monitoring installation as determined by the at least one analyzer mechanism at a second time; (c) comparing the baseline location to the second location; (d) determining if a change between the baseline location and the second location indicative of a change in a position of the underground installation exists; (e) repeating steps (a) through (d) after a pre-determined time period has elapsed; and (f) alerting a user if a change between the baseline location and the second location exists. The monitoring installation may be a pipe attached to at least a portion of the underground installation.

Still further provided is an article having a machine-readable storage medium containing instructions that, if executed, enable a processor to receive data transmitted from at least one analyzer mechanism configured to measure at least one physical characteristic associated with a monitoring installation associated with an underground installation and determine a location of the monitoring installation.

In addition, provided is an underground installation monitoring software stored on a storage medium to monitor an underground installation, the software having programming instructions that, if executed, enable a processor to receive data transmitted from at least one analyzer mechanism configured to measure at least one physical characteristic associated with a monitoring installation associated with an underground installation and determine a location of the monitoring installation.

Still further provided is a method for non-invasively monitoring an underground installation. The method includes the steps of: associating at least one monitoring installation with the underground installation; measuring, by at least one analyzer mechanism, at least one physical characteristic of a pipeline, thereby creating a measurement data set at least partially representative of the at least one physical characteristic; transmitting, from the at least one analyzer mechanism, at least a portion of the measurement data set; receiving the transmitted measurement data set on at least one computer; and determining a location of the monitoring installation based at least in part on the transmitted measurement data set. The method may further include the step of monitoring a location of the underground installation based at least in part on the determined location of the monitoring installation.

The step of measuring may include: placing the at least one analyzer mechanism into the monitoring installation; moving the at least one analyzer mechanism through the monitoring installation; measuring the at least one physical characteristic using internal data collection instrumentation of the at least one analyzer mechanism; and storing the measured at least one physical characteristic on a storage device of the at least one analyzer mechanism.

The step of monitoring may include: (a) determining a baseline location of the monitoring installation based on the at least one physical characteristic associated with the at least one monitoring installation as determined by the at least one analyzer mechanism at a first time; (b) determining a second location of the monitoring installation based on the at least one physical characteristic associated with the at least one monitoring installation as determined by the at least one analyzer mechanism at a second time; (c) comparing the baseline location to the second location; (d) determining if a change between the baseline location and the second location indicative of a change in a position of the underground installation exists; (e) repeating steps (a) through (d) after a pre-determined time period has elapsed; and (f) alerting a user if a change between the baseline location and the second location exists.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a block diagram illustrating an exemplary system for a system for determining location data related to underground installations;

FIG. 2 is a block diagram illustrating an exemplary system for non-invasive monitoring of underground installations;

FIG. 3 is a flow chart illustrating a method of non-invasively monitoring an underground installation in accordance with the present invention;

FIG. 4 is perspective view of an underground installation in accordance with the present invention;

FIG. 5 is a perspective view of the underground installation of FIG. 4 with a monitoring installation associated therewith in accordance with the present invention; and

FIG. 6 is a flow chart illustrating a method of analyzing data from an analyzer mechanism to monitor the location of an underground installation in accordance with the present invention.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

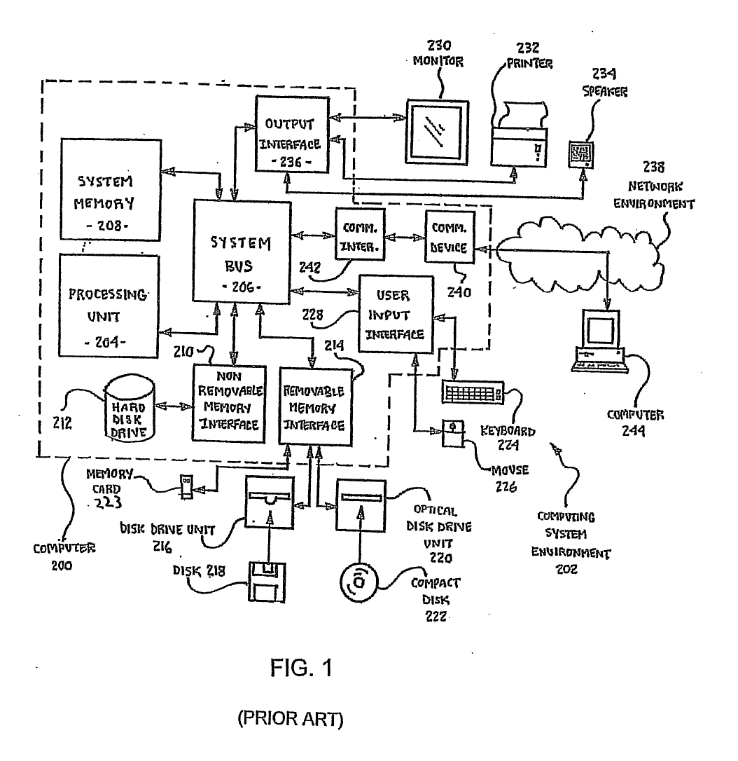

The present invention may be implemented on a variety of computing devices and systems, wherein these computing devices include the appropriate processing mechanisms and computer-readable media for storing and executing computer-readable instructions, such as programming instructions, code, and the like. As illustrated in FIG. 1 and according to the prior art, a schematic and block diagram of exemplary computing devices, in the form of personal computers 200, 244, in a computing system environment 202 are provided. This computing system environment 202 may include, but is not limited to, at least one computer 200 having certain components for appropriate operation, execution of code, and creation and communication of data. For example, the computer 200 includes a processing unit 204 (typically referred to as a central processing unit or CPU) that serves to execute computer-based instructions received in the appropriate data form and format. Further, this processing unit 204 may be in the form of multiple processors executing code in series, in parallel, or in any other manner for appropriate implementation of the computer-based instructions.

In order to facilitate appropriate data communication and processing information between the various components of the computer 200, a system bus 206 is utilized. The system bus 206 may be any of several types of bus structures, including a memory bus or memory controller, a peripheral bus, or a local bus using any of a variety of bus architectures. In particular, the system bus 206 facilitates data and information communication between the various components (whether internal or external to the computer 200) through a variety of interfaces, as discussed hereinafter.

The computer 200 may include a variety of discrete computer-readable media components. For example, this computer-readable media may include any media that can be accessed by the computer 200, such as volatile media, non-volatile media, removable media, non-removable media, etc. As a further example, this computer-readable media may include computer storage media, such as media implemented in any method or technology for storage of information such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 200. Further, this computer-readable media may include communications media, such as computer-readable instructions, data structures, program modules, or other data in a modulated data signal such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 200 further includes a system memory 208 with computer storage media in the form of volatile and non-volatile memory, such as ROM and RAM. A basic input/output system (BIOS) with appropriate computer-based routines assists in transferring information between components within the computer 200 and is normally stored in ROM. The RAM portion of the system memory 208 typically contains data and program modules that are immediately accessible to or presently being operated on by processing unit 204, e.g., an operating system, application programming interfaces, application programs, program modules, program data, and other instruction-based computer-readable code.

The computer 200 may also include other removable or non-removable, volatile or non-volatile computer storage media products. For example, the computer 200 may include a non-removable memory interface 210 that communicates with and controls a hard disk drive 212, i.e., a non-removable, non-volatile magnetic medium, a removable, non-volatile memory interface 214 that communicates with and controls a magnetic disk drive unit 216 (which reads from and writes to a removable, non-volatile magnetic disk 218), an optical disk drive unit 220 (which reads from and writes to a removable, non-volatile optical disk, such as a CD ROM 222), a Universal Serial Bus (USB) port for use in connection with a removable memory card 223, etc. However, it is envisioned that other removable or non-removable, volatile or non-volatile computer storage media can be used in the exemplary computing system environment 202, including, but not limited to, magnetic tape cassettes, DVDs, digital video tape, solid state RAM, solid state ROM, etc. These various removable or non-removable, volatile or non-volatile magnetic media are in communication with the processing unit 204 and other components of the computer 200 via the system bus 206. The drives and their associated computer storage media discussed above and illustrated in FIG. 1 provide storage of operating systems, computer-readable instructions, application programs, data structures, program modules, program data, and other instruction-based computer-readable code for the computer 200 (whether duplicative or not of the information and data in the system memory 208).

A user may enter commands, information, and data into the computer 200 through certain attachable or operable input devices, such as a keyboard 224, a mouse 226, etc., via a user input interface 228. Of course, a variety of such input devices may be utilized, e.g., a microphone, a trackball, a joystick, a touchpad, a touch-screen, a scanner, etc., including any arrangement that facilitates the input of data and information to the computer 200 from an outside source. As discussed, these and other input devices are often connected to the processing unit 204 through the user input interface 228 coupled to the system bus 206, but may be connected by other interface and bus structures, such as a parallel port, game port, or a USB. Still further, data and information can be presented or provided to a user in an intelligible form or format through certain output devices, such as a monitor 230 (to visually display this information and data in electronic form), a printer 232 (to physically display this information and data in print form), a speaker 234 (to audibly present this information and data in audible form), etc. All of these devices are in communication with the computer 200 through an output interface 236 coupled to the system bus 206. It is envisioned that any such peripheral output devices be used to provide information and data to the user.

The computer 200 may operate in a network environment 238 through the use of a communications device 240, which is integral to the computer or remote therefrom. This communications device 240 is operable by and in communication with the other components of the computer 200 through a communications interface 242. Using such an arrangement, the computer 200 may connect with or otherwise communicate with one or more remote computers, such as a remote computer 244, which may be a personal computer, a server, a router, a network personal computer, a peer device, or other common network node, and typically includes many or all of the components described above in connection with the computer 200. Using appropriate communications devices 240, e.g., a modem, a network interface, or adapter, etc., the computer 200 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 200, 244 may be used.

As used herein, the computer 200 includes or is operable to execute appropriate custom-designed or conventional software to perform and implement the processing steps of the method and system of the present invention, thereby forming a specialized and particular computing system. Accordingly, the presently-invented method and system may include one or more computers 200 or similar computing devices having a computer-readable storage medium capable of storing computer-readable program code or instructions that cause the processing unit 204 to execute, configure, or otherwise implement the methods, processes, and transformational data manipulations discussed hereinafter in connection with the present invention. Still further, the computer 200 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

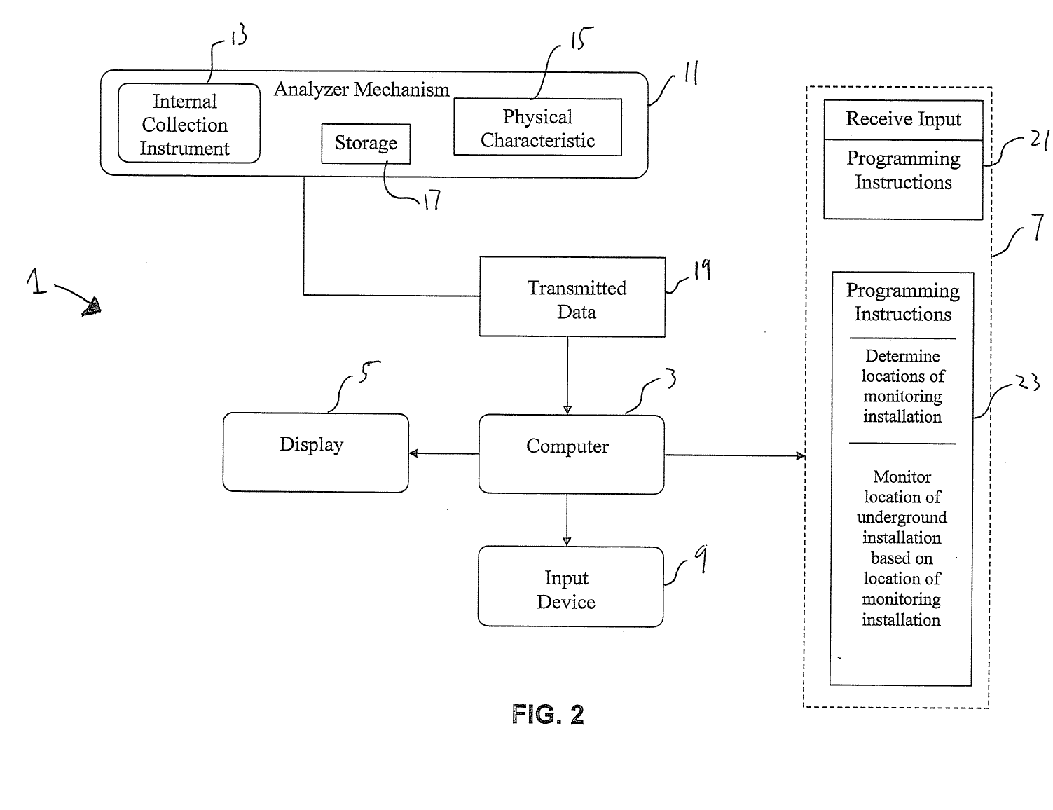

With reference to FIG. 2, one exemplary and non-limiting embodiment of a system, denoted generally as reference numeral 1, for non-invasively monitoring underground installations is provided. System 1 includes at least one computer 3 having some or all of the characteristics of computer 200 discussed hereinabove with reference to FIG. 1 and at least a display 5, a processing unit for reading a computer-readable medium 7, and at least one input device 9.

System 1 further includes an analyzer mechanism 11 that includes internal collection instruments 13 that measure an underground structure and produce physical characteristics 15 of the underground structure based on measurements taken by internal collection instruments 13. A detailed description of analyzer mechanism 11 is provided in related, co-pending U.S. patent application Ser. No. 12/484,586, filed Jun. 15, 2009, which has been incorporated by reference in its entirety. Analyzer mechanism 11 may be embodied as an inertial-based mapping probe and physical characteristics 15 may be determined based on at least the following measurements taken by the probe: (1) distance traveled; (2) depth; (3) elevation; (4) angle; (5) change in inclination; and (6) speed of the probe. The physical characteristic data can reside on a storage medium 17 of analyzer mechanism 11.

Computer 3 is configured to receive and process transmitted data 19 from analyzer mechanism 11. More specifically, computer-readable medium 7 of system 1 includes programming instructions 21 to control the processor of computer 3 to receive the transmitted data 19 from analyzer mechanism 11. Computer-readable medium 7 also includes programming instructions 23 for determining location data related to a monitoring installation and for monitoring the location of underground installations based on the information received from analyzer mechanism 11 as will be discussed in greater detail hereinafter. Accordingly, the programming instructions 23 include instructions for performing the functions described hereinafter.

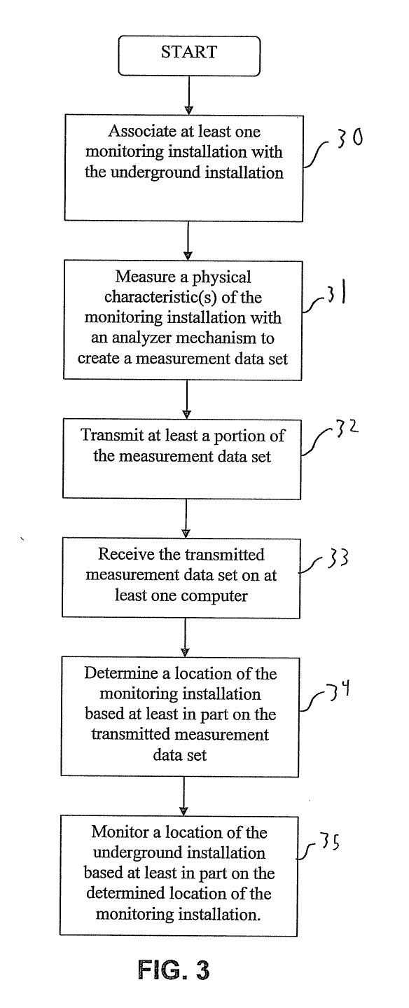

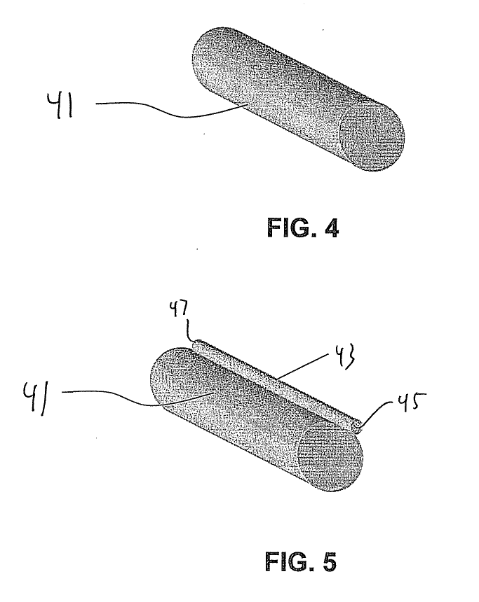

With reference to FIG. 3, a high level overview of the method performed by system 1 to monitor an underground installation is provided. The process begins at step 30 where a monitoring installation is associated with the underground installation. Thereafter, at step 31, at least one physical characteristic of the monitoring installation is measured with analyzer mechanism 11 to create a measurement data set. Then, at step 32, at least a portion of the measurement data set is transmitted to computer 3. The transmitted measurement data set is then received by computer 3 at step 33. Next, at step 34, location data related to the monitoring installation is determined based at least in part on the transmitted measurement data set. Finally, a location of the underground. installation is monitored based at least in part on the determined location of the monitoring installation at step 35. The above described process will be described in greater detail hereinafter with reference to FIGS. 4-6.

With reference to FIGS. 4 and 5, and with continuing reference to FIGS. 2 and 3, the step of associating the monitoring installation to the underground installation (step 30) is as follows. First, an underground installation that needs to be monitored is selected. For exemplary purposes, the underground installation will be described hereinafter as a carrier pipeline 41 as shown in FIG. 4. However, this is not to be construed as limiting the present invention as any underground installation, object, or structure may be monitored using system 1 of the present invention. Thereafter, a monitoring installation 43, such as a “sister” pipe, is associated with carrier pipeline 41. Monitoring installation 43 may be attached to, positioned near, or otherwise associated with carrier pipeline 41. If monitoring installation 43 is attached to carrier pipeline 41, the means or mechanism of attachment may be adhesive, arc welding, thermo welding, fusing, strapping, any combination thereof, or any and all means available or that may become available. This means or mechanism of attachment may also be manufactured from materials that are compatible with monitoring installation 43 and/or carrier pipeline 41.

Monitoring installation 43 may be manufactured from a variety of materials, and preferably materials that are compatible with the material from which carrier pipeline 41 is manufactured. For example, monitoring installation 43 may be manufactured from steel, aluminum, ductile iron, cast iron, concrete, asbestos, concrete asbestos, titanium, high density polyethylene, polyvinyl chloride, or an as yet to be invented or conceived material. However, it should be noted that carrier pipeline 41 and monitoring installation 43 do not necessarily need to be made from the same material.

In addition, it is desirable that monitoring installation 43 and carrier pipeline 41 are continuously joined or associated along at least a substantial portion thereof as shown in FIG. 5. For example, monitoring installation 43 and the carrier pipe 41 may be strapped or welded together at specified locations along their respective lengths. Monitoring installation 43 may be attached to carrier pipeline 41 at the time of initial construction or as a retrofit.

Once installed, monitoring installation 43 is accurately located based on measurements of physical characteristics 15 thereof with analyzer mechanism 11 at step 31. As described hereinabove, analyzer mechanism 11 may be embodied as an inertial-based mapping probe. However, this is not to be construed as limiting the present invention as any suitable analyzer mechanism capable of measuring a physical characteristic of an underground installation may be utilized.

Analyzer mechanism 11 includes internal data collection instruments 13 and components that measure at least the following: (1) distance traveled; (2) depth; (3) elevation; (4) angle; (5) change in inclination; and (6) speed of the probe. In addition, it further includes an internal storage medium 17 that stores the information collected, allowing the analyzer mechanism to travel autonomously and untethered through the underground installation.

Analyzer mechanism 11 may also include communication devices to transfer, wirelessly, data it receives either immediately, at a programmed time, or at a set interval while traveling through monitoring installation 43. Analyzer mechanism 11 includes an array of data collection instruments which include accelerometers, gyroscopes, and odometers located within each of the probe bodies thereof. As analyzer mechanism 11 moves through the underground installation, it can record all changes in inclination, heading, and velocity at a rate of 800 times per second. This information is stored on storage medium 17 within analyzer mechanism 11.

Analyzer mechanism 11 is not restricted by the depth of ground cover over the monitoring installation 43 nor is it subject to possible interference derived from other underground installations or metals located within the soil. There is no requirement to “trace” the movement of analyzer mechanism 11 from above ground. Analyzer mechanism 11 is provided with its starting coordinates and its ending coordinates, and internal data collection instruments 13, along with the software, record everywhere that analyzer mechanism 11 travels between those known coordinates.

Depending on the interior surface and condition of monitoring installation 43, various wheel-sets with protruding carrier legs are used to assure the positioning of the probe body of analyzer mechanism 11 within the underground installation. The ability to economically design and develop multiple specifications for the probe bodies or carriers of analyzer mechanism 11 and utilize the same instrumentation modules is a key element to the analyzer mechanism technology. The probe bodies of analyzer mechanism 11 may be modified to allow operations in high pressure, high temperature, and many caustic environments. The basic analyzer mechanism 11 is designed for use within a non-pressurized pipeline environment. However, analyzer mechanisms 11 have been designed and are in use in pressurized environments up to 6.55 bar (95 psi). Analyzer mechanisms 11 may be capable of operating in environments up to 241 bar (3500 psi) with battery and memory capacities allowing for very long distance runs.

Analyzer mechanism 11 may have over thirty instruments to collect approximately 800 accurate readings per second as the probe moves within monitoring installation 43. This physical characteristic data is saved on storage medium 17 within analyzer mechanism 11 and then transmitted at the end of the run to computer 3. The physical characteristic data collection method type is not meant to be a limiting feature of the invention as one skilled in the art may envision other known techniques to measure the physical characteristics of the pipeline.

To perform the step of measuring a physical characteristic of monitoring installation 43, analyzer mechanism 11 is inserted into an opening 45 in monitoring installation 43 and travels to another opening 47 located a distance away from the initial opening 45. Openings 45, 47 in monitoring installation 43 are made accessible by placing them at convenient locations to facilitate the introduction of analyzer mechanism 11. Openings 45, 47 may be placed above ground or below ground in a manhole, hand box, or any device deemed suitable for such a purpose.

After surveying monitoring installation 43, analyzer mechanism 11 is removed from opening 47 of monitoring installation 43. Analyzer mechanism 11 communicates with a physical characteristics analyzer, a computer, or other data holding device having programming instructions to perform calculations. An example of such a computer 3 is described hereinabove with reference to FIG. 2. The physical characteristic data is then transmitted by analyzer mechanism 11 to computer 3 where it can be processed or stored in memory on computer 3. The transmission can occur via USB or other wired communication techniques, or also using wireless or memory storage cards and disks. Programming instructions 21 on computer 3 operate a processor to process the transmitted data 19 from all the instruments in analyzer mechanism 11 and process and convert the data into a readable format describing the analyzer mechanism's exact location in three dimensions, i.e., X-Y-Z data, at any given point along the underground installation as follows:
763594.870000, 2877717.700000, 210.470000
763594.413419, 2877719.926949, 210.463260
763594.413419, 2877719.926949, 210.463260
763594.265899, 2877720.646380, 210.460034
763594.064304, 2877721.629357, 210.455267
763593.863577, 2877722.606496, 210.451348
763593.660874, 2877723.592634, 210.448455

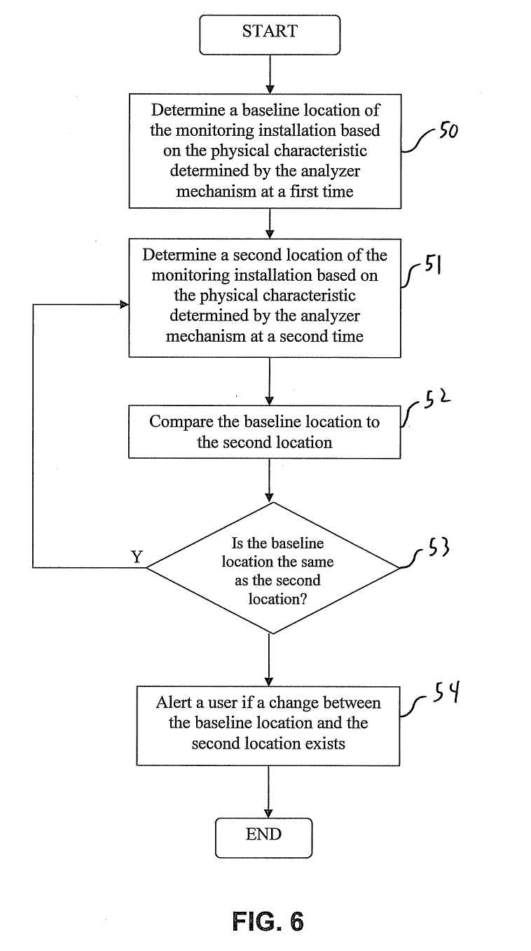

With reference to FIG. 6, and with continuing reference to FIGS. 1-5, a baseline location of monitoring installation 43 based on the physical characteristics 15 determined by analyzer mechanism 11 is determined at step 50 as follows. The readable X-Y-Z data is inserted into a model that represents the in-place location of monitoring installation 43, which is associated with or attached to carrier pipeline 41. Next, the X-Y-Z data or points will be connected via a line segment in the order that they were collected. All the points collected from one pipeline will be connected to form a complex line representing monitoring installation 43 or an attribute of monitoring installation 43, such as the centerline of monitoring installation 43. The steps of analyzing the X-Y-Z data is discussed in greater detail in related, co-pending U.S. patent application Ser. No. 12/484,586, filed Jun. 15, 2009, which has been incorporated by reference in its entirety. In this manner, an initial, baseline location of monitoring installation 43 is determined. This initial, baseline location is stored and used for comparison with future determined locations of monitoring installation 43.

After a predetermined time interval or intervals have passed, monitoring installation 43 will again be accurately located by the same method as was utilized for the determination of the initial, baseline location of monitoring installation 43 at step 51. Then, at step 52, the data captured at each interval is compared to the baseline data to determine if the location of monitoring installation 43 has changed. Any change in location will indicate a potential issue with the integrity of the carrier pipeline. At decision block 53, if it is determined that there has been no change in location, steps 51 and 52 are repeated. Monitoring can be done on a constant, regularly scheduled or random basis, depending upon need. However, if it is determined at decision block 53 that there has been a change in location of monitoring installation 43, a user is alerted at step 54 that a change in location of the monitoring installation 43 has occurred. This change in location corresponds to a change in location of carrier pipeline 41 because monitoring installation 43 is associated with carrier pipeline 41 as described hereinabove. The user may be alerted by a message on display 5, an audible alarm, or any other suitable alerting mechanism. In this manner, the system and method of the present invention can determine if any adverse conditions or events have led to the movement of carrier pipeline 41 (or other monitored installation, structure, or object).

Accordingly, the present invention provides a cost effective monitoring system that monitors for unwanted pipeline movement, thereby facilitating the safe operation of pipelines and other underground installations. More specifically, the method, apparatus, and system of the present invention is configured to: (1) monitor monitoring installation 43 that is attached to or otherwise associated with the pipe-to-be-monitored, or carrier pipeline 41; and (2) determine or produce movement data using analyzing mechanism 11, such as an autonomous, inertial-based mapping probe.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is:

1. A system for non-invasive monitoring of an underground installation, comprising:
at least one monitoring installation associated with the underground installation;
at least one analyzer mechanism configured to measure at least one physical characteristic associated with the at least one monitoring installation and transmit a data set at least partially representative of the at least one measured physical characteristic; and
at least one computer having a computer-readable medium having stored thereon instructions, which, when executed by a processor of the computer, causes the processor to implement the instructions, wherein the at least one computer is in communication with an input mechanism and a display unit, the at least one computer comprising programming instructions adapted to operate the processor to receive the transmitted data set, and adapted to operate the processor to determine a location of the monitoring installation based at least in part on the transmitted data set.

2. The system as defined in claim 1, wherein the at least one monitoring installation is associated with the underground installation by being one of coupled to the underground installation and positioned near the underground installation.

3. The system as defined in claim 2, wherein the at least one monitoring installation is coupled to the underground installation by at least one of the following: adhesive, arc welding, thermo welding, fusing, strapping, or any combination thereof.

4. The system as defined in claim 1, wherein the at least one monitoring installation is manufactured from at least one of the following: steel, aluminum, ductile iron, cast iron, concrete, asbestos, concrete asbestos, titanium, high density polyethylene, polyvinyl chloride, or any combination thereof.

5. The system as defined in claim 1, wherein the at least one analyzer mechanism is a probe including:
internal data collection instrumentation configured to measure the at least one physical characteristic; and
a storage device configured to store collected data.

6. The system as defined in claim 1, wherein the at least one physical characteristic includes at least one of the following: distance traveled, depth, elevation, angle, change in inclination, change in speed, or any combination thereof.

7. The system as defined in claim 1, wherein the at least one analyzer mechanism further comprises a communications interface to transmit the data set to the at least one computer.

8. The system as defined in claim 1, wherein the at least one computer further comprises programming instructions adapted to operate the processor to convert the data received from the at least one analyzer mechanism into a readable format.

9. The system as defined in claim 1, wherein the received data comprises physical characteristic data in three dimensions at at least one specified point along the monitoring installation.

10. The system as defined in claim 1, wherein the at least one computer further comprises programming instructions adapted to operate the processor to generate a three-dimensional array of X-Y-Z data representative of physical characteristics of the at least one monitoring installation.

11. The system as defined in claim 10, wherein the at least one computer further comprises programming instructions adapted to operate the processor to insert the X-Y-Z data into a model and connect points of the X-Y-Z data to form a complex line representing the at least one monitoring installation.

12. The system as defined in claim 10, wherein the at least one computer further comprises programming instructions to operate the processor to monitor a position of the underground installation by:
a) determining a baseline location of at least a portion of the monitoring installation based on the at least one physical characteristic associated with the at least one monitoring installation as determined by the at least one analyzer mechanism at a first time;
b) determining a second location of at least a portion of the monitoring installation based on the at least one physical characteristic associated with the at least one monitoring installation as determined by the at least one analyzer mechanism at a second time;
c) comparing the baseline location to the second location;
d) determining if a change between the baseline location and the second location indicative of a change in a position of the underground installation exists;
e) repeating steps (a) through (d) after a predetermined time period has elapsed; and
f) alerting a user if a change between the baseline location and the second location exists,
wherein the monitoring installation is a pipe attached to at least a portion of the underground installation.

13. A computer-implemented method on at least one computer having a computer-readable medium having stored thereon instructions, which when executed by a processor of the computer, causes the processor to implement the method, comprising:
receiving data transmitted from at least one analyzer mechanism configured to measure at least one physical characteristic associated with a monitoring installation associated with an underground installation; and
determining a location of the monitoring installation.

14. The computer-implemented method as defined in claim 13, wherein the at least one monitoring installation is associated with the underground installation by being one of coupled to the underground installation and positioned near the underground installation.

15. The computer-implemented method as defined in claim 13, wherein the at least one physical characteristic includes at least one of the following: distance traveled, depth, elevation, angle, change in inclination, change in speed, or any combination thereof.

16. The computer-implemented method as defined in claim 13, further comprising the step of generating a three-dimensional array of X-Y-Z data representative of physical characteristics of the at least one monitoring installation.

17. The computer-implemented method as defined in claim 16, further comprising the step of inserting the X-Y-Z data into a model and connecting points of the X-Y-Z data to form a complex line representing the at least one monitoring installation.

18. The computer-implemented method as defined in claim 16, further comprising the step of monitoring a position of the underground installation by:
a) determining a baseline location of at least a portion of the monitoring installation based on the at least one physical characteristic associated with the at least one monitoring installation as determined by the at least one analyzer mechanism at a first time;
b) determining a second location of at least a portion of the monitoring installation based on the at least one physical characteristic associated with the at least one monitoring installation as determined by the at least one analyzer mechanism at a second time;
c) comparing the baseline location to the second location;
d) determining if a change between the baseline location and the second location indicative of a change in a position of the underground installation exists;
e) repeating steps (a) through (d) after a predetermined time period has elapsed; and
f) alerting a user if a change between the baseline location and the second location exists,
wherein the monitoring installation is a pipe attached to at least a portion of the underground installation.

19. An article comprising a machine-readable storage medium containing instructions that, if executed, enable a processor to:
receive data transmitted from at least one analyzer mechanism configured to measure at least one physical characteristic associated with a monitoring installation associated with an underground installation; and
determine a location of the monitoring installation.

20. An underground installation monitoring software stored on a storage medium to monitor an underground installation, the software comprising programming instructions that, if executed, enable a processor to:
receive data transmitted from at least one analyzer mechanism configured to measure at least one physical characteristic associated with a monitoring installation associated with an underground installation; and
determine a location of the monitoring installation.

21. A method for non-invasively monitoring an underground installation, comprising:
associating at least one monitoring installation with the underground installation;
measuring, by at least one analyzer mechanism, at least one physical characteristic of a pipeline, thereby creating a measurement data set at least partially representative of the at least one physical characteristic;
transmitting, from the at least one analyzer mechanism, at least a portion of the measurement data set;
receiving the transmitted measurement data set on at least one computer; and
determining a location of the monitoring installation based at least in part on the transmitted measurement data set.

22. The method of claim 21, wherein the step of measuring further comprises:
placing the at least one analyzer mechanism into the monitoring installation;
moving the at least one analyzer mechanism through the monitoring installation;
measuring the at least one physical characteristic using internal data collection instrumentation of the at least one analyzer mechanism; and
storing the measured at least one physical characteristic on a storage device of the at least one analyzer mechanism.

23. The method of claim 21, further comprising:
monitoring a location of the underground installation based at least in part on the determined location of the monitoring installation.

24. The method of claim 23, wherein the step of monitoring comprises:
a) determining a baseline location of the monitoring installation based on the at least one physical characteristic associated with the at least one monitoring installation as determined by the at least one analyzer mechanism at a first time;
b) determining a second location of the monitoring installation based on the at least one physical characteristic associated with the at least one monitoring installation as determined by the at least one analyzer mechanism at a second time;
c) comparing the baseline location to the second location;
d) determining if a change between the baseline location and the second location indicative of a change in a position of the underground installation exists;
e) repeating steps (a) through (d) after a predetermined time period has elapsed; and
f) alerting a user if a change between the baseline location and the second location exists.
